(19) United States
(12) Patent Application Publication
(10) Pub. No.: US 2025/0340160 A1
(43) Pub. Date: Nov. 6, 2025

(54) ADJUSTABLE VEHICLE CUP HOLDER

(71) Applicant: GM Global Technology Operations LLC, Detroit, MI (US)

(72) Inventors: Minseok Jeon, Gimpo City (KR); Junghoon Kim, Seoul (KR); Yongkeun Cho, Seoul (KR); Sanghyok Yoon, Seoul (KR); Minsu Lee, Gyeonggi-do (KR)

(73) Assignee: GM Global Technology Operations LLC, Detroit, MI (US)

(21) Appl. No.: 18/655,947

(22) Filed: May 6, 2024

(51) Int. Cl. B60N 3/10

(52) U.S. Cl. CPC B60N 3/105

(57) ABSTRACT

An adjustable cup holder assembly comprising a receptacle extending along a first axis, a first rail arranged in the receptacle and parallel to the first axis, and a divider arranged in the receptacle and movable along the first axis, the divider defining a first compartment and a second compartment in the receptacle. The cup holder assembly further comprising a second rail arranged in the divider along a second axis that is perpendicular to the first axis, a base arranged in the receptacle and movable with respect to the second axis, a first mechanism coupled to the divider and the first rail, the first mechanism being configured to adjust the position of the divider with respect to the first axis, and a second mechanism coupled to the base and the second rail, the second mechanism being configured to adjust the position of the base with respect to the second axis.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a cup holder and, more particularly, to an adjustable cup holder.

Traditionally, center console cup holders cannot be adjusted to accommodate a variety of containers (e.g., cups, bottles, etc.). Failing to properly secure containers within the cup holders can result in spills, instability, and/or wasted space. Aspects of the present disclosure address one or more shortcomings of existing systems.

### SUMMARY

According to one configuration, an adjustable cup holder assembly is provided and includes a receptacle extending along a first axis, a first rail arranged in the receptacle and parallel to the first axis, a divider arranged in the receptacle and movable along the first axis, the divider defining a first compartment and a second compartment in the receptacle, a second rail arranged in the divider along a second axis that is perpendicular to the first axis, a base arranged in the receptacle and movable with respect to the second axis, a first mechanism coupled to the divider and the first rail, the first mechanism being configured to adjust the divider with respect to the first axis, and a second mechanism coupled to the base and the second rail, the second mechanism being configured to adjust the base with respect to the second axis.

Implementations of the disclosure may include one or more of the following optional features. For example, the receptacle can include a floor and a continuous wall defining a first end and a second end, the first end being opposite the second end with respect to the first axis. The divider can include a first side that faces the first end of the receptacle and a second side that faces the second end of the receptacle. The first compartment can be defined between the first side and the first end and the second compartment can be defined between the second side and the second end. The divider can be movable so that a first diameter of the first compartment is larger than, smaller than, or the same size as a second diameter of the second compartment.

According to at least one example, the adjustable cup holder assembly can further include a first dial coupled to the first mechanism and configured to adjust the divider with respect to the first axis. The adjustable cup holder can further include a second dial coupled to the second mechanism and configured to adjust the base with respect to the second axis. The first mechanism can further include a first bevel gear configured to rotate about a third axis, a second bevel gear configured to rotate about a first rail axis and in communication with the first bevel gear, and a worm gear coupled to the second bevel gear and arranged to communicate with the first rail. The second mechanism can further include a first bevel gear configured to rotate about a third axis, a second bevel gear configured to rotate about a second rail axis and in communication with the first bevel gear, and a worm gear coupled to the second bevel gear along a shaft and arranged to communicate with the second rail.

According to at least one aspect, the base can further include a first pad and a second pad coupled to the first pad via a support member.

In another configuration, a vehicle cup holder assembly is provided and includes a cup holder base that is movable within a receptacle, a first cup holder compartment having a first diameter between a first side of a divider and a first end of the receptacle, a second cup holder compartment having a second diameter between a second side of the divider and a second end of the receptacle, a first interface defining a first dial opening and comprising a first dial within the first dial opening, a second interface defining a second dial opening and comprising a second dial within the second dial opening, a first finger operated mechanism coupled to the first interface and configured to move the divider with respect to a first axis, and a second finger operated mechanism coupled to the second interface and configured move the cup holder base with respect to a second axis that is perpendicular to the first axis.

Implementations of the disclosure may include one or more of the following optional features. For example, the first finger operated mechanism can be configured to adjust the first diameter and the second diameter. The second finger operated mechanism can be configured to move the cup holder base with respect to an upper surface of the receptacle.

According to at least one example, the cup holder base further includes a first pad extending into the first cup holder compartment and a second pad extending into the second cup holder compartment, the first pad being coupled to the second pad via a support member.

According to at least one aspect, the first dial and the second dial are configured to rotate with respect to a third axis that is perpendicular to the first axis and the second axis.

In yet another configuration, a method for adjusting a depth and a width within a cup holder is provided and includes actuating a first interface to adjust a diameter of a first compartment and a second compartment, actuating a second interface to adjust a depth of a first compartment and a second compartment, and positioning a container within the first compartment or the second compartment.

Implementations of the disclosure may include one or more of the following optional features. For example, the first interface can be a first finger operated mechanism comprising a first dial. The second interface can be a second finger operated mechanism comprising a second dial. Actuating the first interface can further include axially moving a divider with respect to a longitudinal axis. Actuating the second interface can further include axially moving a base with respect to a vertical axis.

### BRIEF DESCRIPTION OF THE DRAWINGS

The drawings described herein are for illustrative purposes only of selected configurations and are not intended to limit the scope of the present disclosure.

FIG. 1 is a perspective view of a portion of a center console including an adjustable cup holder;

FIG. 2 is a top perspective view of the adjustable cup holder of FIG. 1;

FIG. 3 is a close up perspective view of the adjustable cup holder of FIG. 1 including a receptacle, a divider, and a base;

FIG. 4 is a close up top view of a first interface of the divider of FIG. 3;

FIG. 5 is a cross-sectional view of the adjustable cup holder of FIG. 3 along line 5-5;

FIG. 6 is a cross-sectional view of the adjustable cup holder of FIG. 3 along line 6-6;

FIG. 7 is a close up perspective view of the adjustable cup holder of FIG. 1 including a receptacle, a divider, and a base;

FIG. 8 is a cross-sectional view of the adjustable cup holder of FIG. 7 along line 8-8; and

FIG. 9 is a flow diagram showing a method of adjusting the adjustable cup holder of FIG. 1.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

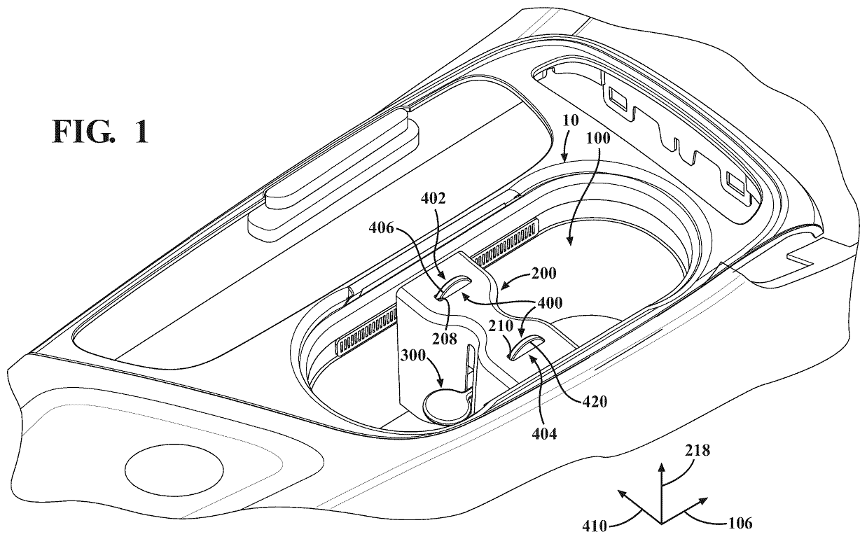

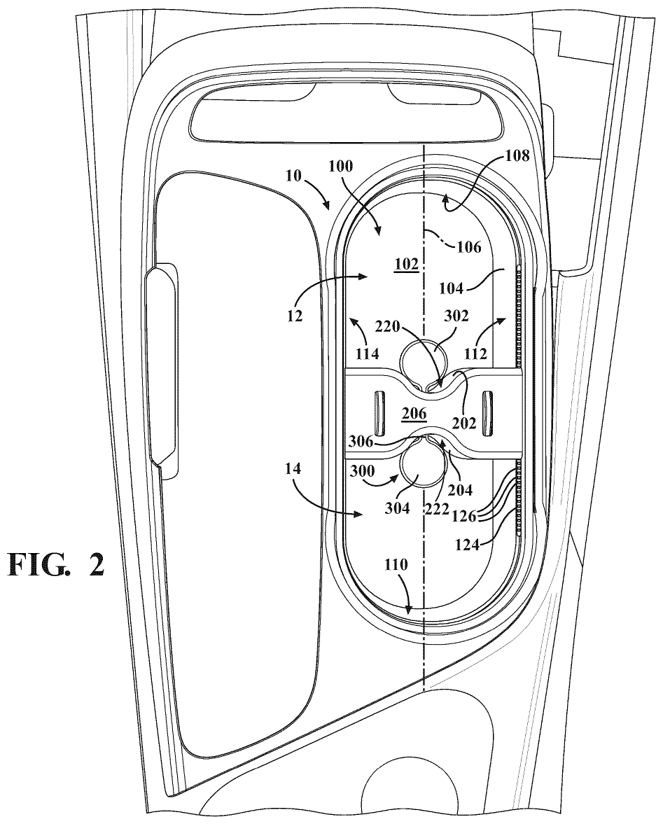

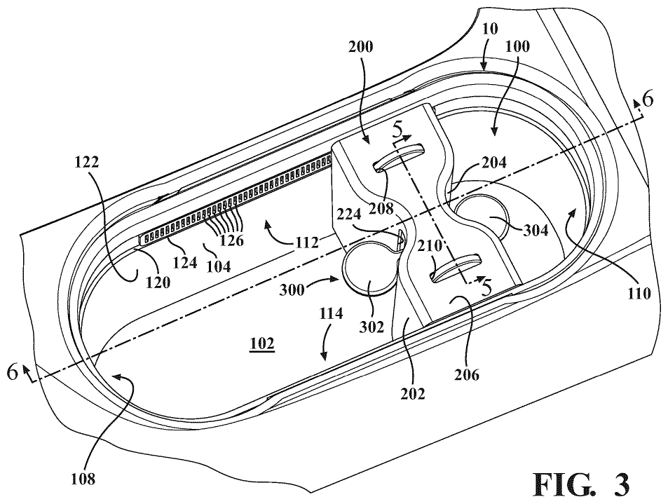

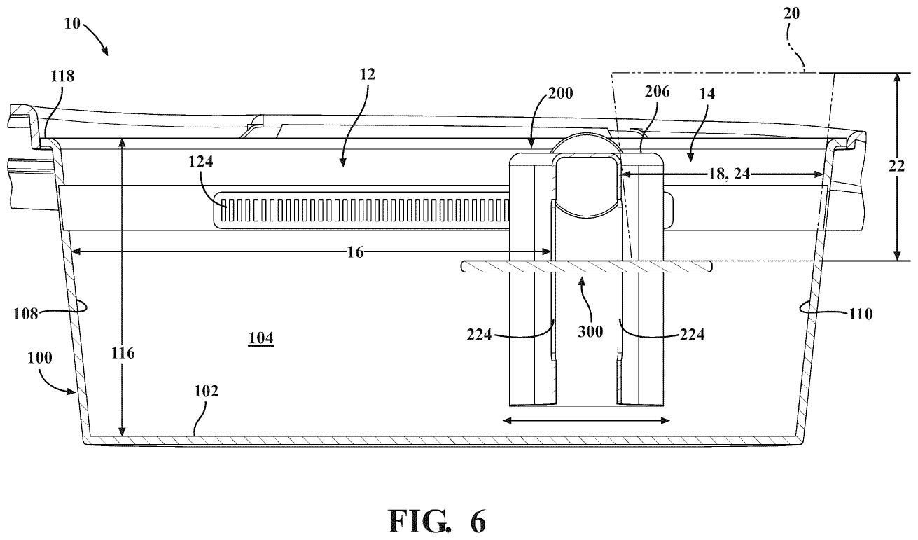

With reference to FIG. 1, a console of a vehicle (e.g., plane, train, automobile, etc.) is shown including an adjustable cup holder 10. The adjustable cup holder 10 includes a receptacle 100, a divider 200, and a base 300. With reference to FIGS. 2 and 3, the receptacle 100 may be configured to receive one or more containers water bottles, coffee cups, mugs, cups, etc. The receptacle 100 can have an oval, rectangular, or another shape that accommodates various container shapes, for example. The receptacle 100 may be defined by a floor 102 and at least one wall 104 extending from the floor 102. The receptacle 100 can extend along a first or longitudinal axis 106 and have a first end 108 and a second end 110 spaced axially from the first end 108 with respect to the first axis 106. Additionally, in the present example, the receptacle 100 includes a first side 112 and a second side 114 spaced from the first side 112 in a direction perpendicular to the first axis 106 (i.e., cross-car in a vehicle example). The receptacle 100 includes a depth 116 (FIG. 6) which may be defined by a distance between an upper surface 118 and the floor 102. The at least one wall 104 may include a slot 120 (FIG. 3) that extends along an interior surface 122 of the at least one wall 104. A first rail 124 comprising teeth 126 may be arranged in the slot 120 on the first side 112 of the receptacle 100.

Some containers (e.g., cans, bottles, cups, etc.) are unusually shaped and/or unusually sized (i.e., small or large) and do not fit well in standard cup holders commonly found in vehicles. Additionally or alternatively, some containers (e.g., a tea cup or a coffee cup) are shorter than usual and can be difficult to access once arranged in a standard cup holder. During travel, unsecured and/or loose containers can create unsafe conditions for one or more passengers in the event of a collision, for example.

With reference to FIG. 3, the divider or separator 200 can be arranged in the receptacle 100 of the adjustable cup holder 10. The divider 200 may be arranged in the receptacle 100 between the first side 112 and the second side 114. The divider 200 can have an hourglass-like shape, which includes a front side 202 that faces the first end 108 of the receptacle 100 and a rear side 204 that faces the second end 110 of the receptacle 100, as shown in FIG. 2. The divider 200 may further include an upper surface 206 coupled to the front side 202 and the rear side 204. With reference to FIG. 3, the upper surface 206 can have a first opening 208 and a second opening 210 that extend through the divider 200 into an interior region 212 (FIG. 5). As shown in FIG. 5, a second rail 214 having teeth 216 may be arranged within the interior region 212 of the divider 200 and extend in a direction parallel to a second or vertical axis 218.

With reference again to FIG. 2, the adjustable cup holder 10 can have a first compartment 12 that can be defined between a first center portion 220 of the front side 202 of the divider 200 and the first end 108 of the receptacle 100. Likewise, the adjustable cup holder 10 can have a second compartment 14 that can be defined between a second center portion 222 of the rear side 204 of the divider 200 and the second end 110 of the receptacle 100. The first compartment 12 can have a first diameter 16 and the second compartment 14 can have a second diameter 18. Depending on the position of the divider 200 within the receptacle 100, the first diameter 16 may be larger than, smaller than, or the same size as the second diameter 18. With reference to FIG. 5, the divider 200 can include slots 224 that extend through the first and second center portions 220, 222 with respect to the first axis 106.

With reference again to FIGS. 2 and 3, the base 300 is arranged with respect to the divider 200. The base 300 can have a first support or pad 302 that is coupled to a second support or pad 304 via a support member 306. The first support 302 can extend into the first compartment 12 and the second pad 304 can extend into the second compartment 14, as shown in FIG. 3. The base 300 is configured so that it can be adjusted axially with respect to the second axis 218. In other words, the base 300 can provide support for one or more containers at different positions along the second axis 218.

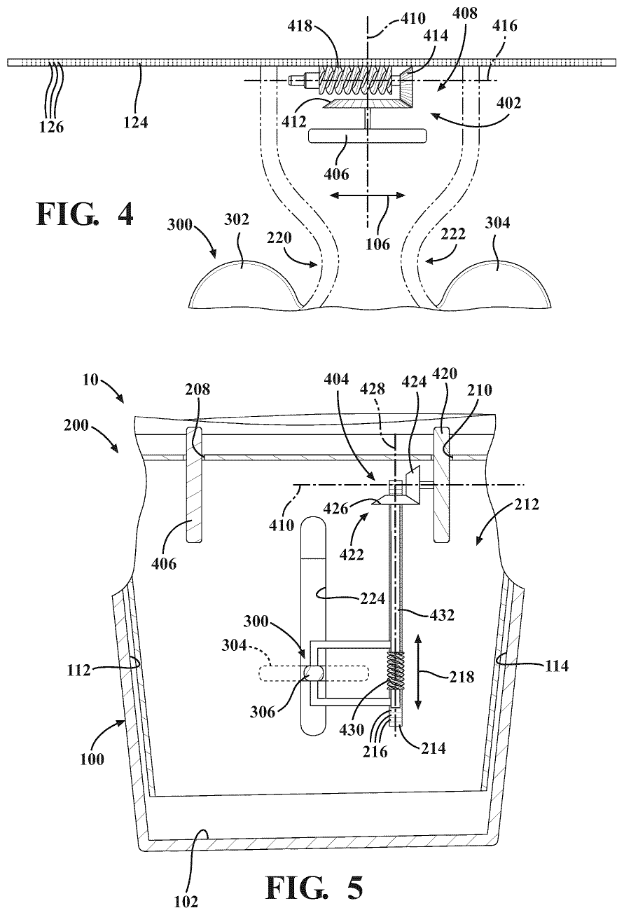

The adjustable cup holder 10 can include one or more interfaces 400 for adjusting the position of the divider 200 and/or the base 300, as shown in FIG. 1. The one or more interfaces 400 can include a first interface 402 for adjusting the position of the divider 200 with respect to the first axis 106 and a second interface 404 for adjusting the position of the base 300 with respect to the second axis 218. The first interface 402 can include an actuating device, such as first dial 406, that is arranged in the first opening 208 of the divider 200 and coupled to a first finger operated mechanism (i.e., first mechanism) 408 (FIG. 4). In at least one configuration, the actuating device is a two-way switch and the first finger operated mechanism 408 is a motor (not shown). The first dial 406 is configured to rotate about a third or lateral axis 410 that is orthogonal to both the first and second axes 106, 218. With reference to FIG. 4, the first finger operated mechanism 408 is arranged in the divider 200 and can include a first bevel gear 412 coupled to the first dial 406. Clockwise rotation of the first dial 406 about the third axis 410 can result in clockwise rotation of the first bevel gear 412 about the third axis 410. Likewise, counter clockwise rotation of the first dial 406 about the third axis 410 can result in counter clockwise rotation of the first bevel gear 412 about the third axis 410. The first finger operated mechanism 408 can include a second bevel gear 414 configured to rotate about a first rail axis 416 that is parallel to the first axis 106. The second bevel gear 414 is engaged with the first bevel gear 412 and is coupled to a worm gear 418. The worm gear 418 can be configured to engage with the teeth 126 of the first rail 124 so that the divider 200 can translate back and forth along the first rail 124. In the present configuration, clockwise rotation of the first bevel gear 412 results in clockwise rotation of the second bevel gear 414 and the worm gear 418 about the first rail axis 416 causing the divider 200 to move axially toward the first end 108 of the receptacle 100. Counter clockwise rotation of the first bevel gear 412 can result in counter clockwise rotation of the second bevel gear 414 and the worm gear 418 about the first rail axis 416 causing the divider 200 to move axially toward the second end 110 of the receptacle 100. Note, the present configuration does not require a stopper or a lock to maintain the axial position of the divider 200. Thus, the axial position of the divider 200 with respect to the first axis 106 can be maintained so long as the position of the first dial 406 remains unchanged.

With reference to FIG. 5, the second interface 404 can include an actuating device, such as a second dial 420, that is arranged in the second opening 210 of the divider 200 and coupled to a second finger operated mechanism (i.e., second mechanism) 422. In at least one configuration, the actuating device is a two-way switch and the second finger operated mechanism 422 is a motor (not shown). The second dial 420 is configured to rotate about the third axis 410. The second finger operated mechanism 422 is arranged in the divider 300 and can include a first bevel gear 424 coupled to the second dial 420. Clockwise rotation of the second dial 420 about the third axis 410 results in clockwise rotation of the first bevel gear 424 about the third axis 410. Likewise, counter clockwise rotation of the second dial 420 about the third axis 410 results in counter clockwise rotation of the first bevel gear 424 about the third axis 410. The second finger operated mechanism 422 can include a second bevel gear 426 configured to rotate about a second rail axis 428 that is parallel to the second axis 218. The second bevel gear 426 is engaged with the first bevel gear 424 and is coupled to a worm gear 430 via a shaft 432. The worm gear 430 can be coupled to the base 300 and, more particularly, to the support member 306 of the base 300. The worm gear 430 can be configured to engage with the teeth 216 of the second rail 214 so that the base 300 can translate up and down with respect to the second rail 214. In the present configuration, clockwise rotation of the first bevel gear 424 results in clockwise rotation of the second bevel gear 426 and the worm gear 430 about the second rail axis 428 causing the base 300 to move axially away from the upper surface 206 of the divider 300. Counter clockwise rotation of the first bevel gear 424 can result in counter clockwise rotation of the second bevel gear 426 and the worm gear 430 about the second rail axis 428 causing the base 300 to move axially toward the upper surface 206 of the divider 200. Note, the present configuration does not require a stopper or a lock to maintain the axial position of the base 300. Thus, the axial position of the base 300 can be maintained with respect to the second axis 218 so long as the position of the second dial 420 remains unchanged.

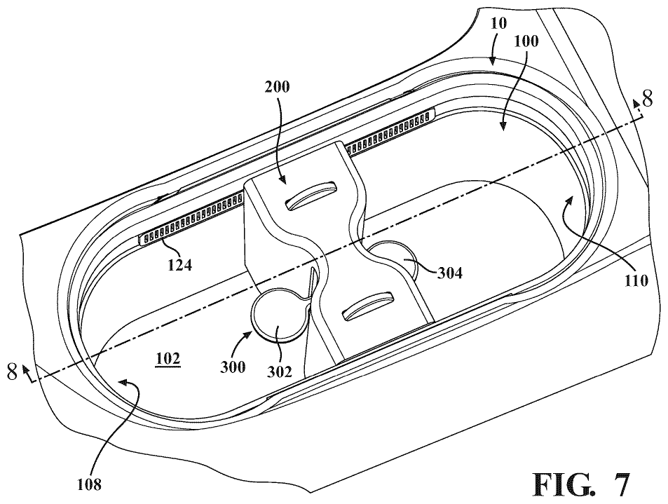

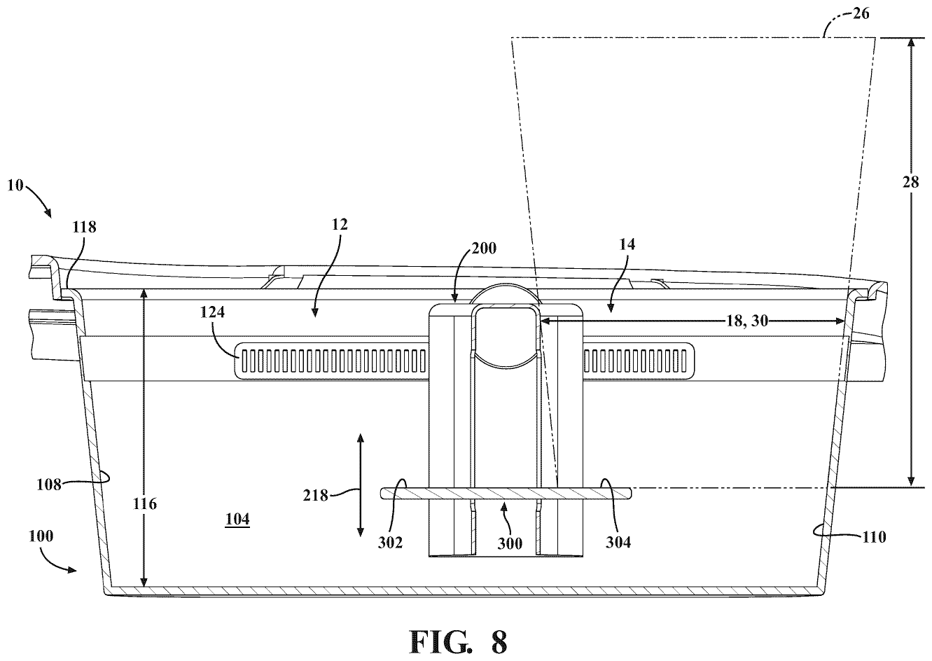

In operation, the adjustable cup holder 10 can be arranged to accommodate containers of many shapes and sizes, such as first container 20 (FIG. 6) having a first container height 22 and a first container diameter 24 or a second container 26 (FIG. 8) having a second container height 28 and a second container diameter 30. With reference to FIGS. 3 and 6, the divider 200 can be arranged toward the second end 110 of the receptacle 100 so that the first diameter 16 of the first compartment 12 can accommodate the first container diameter 24. In other words, the divider 200 can be adjusted so that the first container 20 can be supported and secured within the second compartment 14. Additionally, the base 300 can be arranged toward the upper surface 206 of the divider 200 (i.e., raise the base 300 in the receptacle 100) so that a portion of the first container height 22 is axially proud with respect to the upper surface 118 of the receptacle 100. In other words, the base 300 can be positioned so that an individual can easily access the first container 20 from the second compartment 14. With reference to FIGS. 7 and 8, the divider 200 can be arranged and/or adjusted toward the first end 108 of the receptacle 100 so that the second diameter 18 of the second compartment 14 can accommodate the second container diameter 30. In other words, the second container 26 can be arranged and secured within the second compartment 14. Additionally, the base 300 can be arranged away from the upper surface 206 of the divider 200 (i.e., lower the base 300 in the receptacle 100) so that a portion of the second container height 28 is axially proud with respect to the upper surface 118 of the receptacle 100. Thus, the base 300 can be positioned to provide more stability for the second container 26 while still allowing an individual to easily access the second container 26 from the second compartment 14.

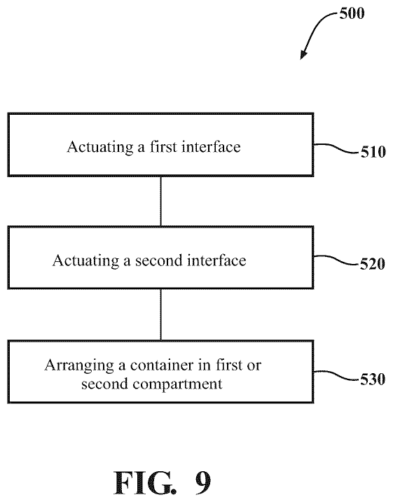

With reference to FIG. 9, a method 500 for adjusting a depth and/or diameter of the first compartment and second compartment of the adjustable cup holder 10 is provided according to the principles of the present disclosure.

At 510, an individual (e.g., a passenger of a vehicle) can actuate the actuating device (e.g., the first dial 406) of the first interface 402 to adjust the first diameter 16 of the first compartment 12 and the second diameter 18 of the second compartment 14. Actuating the first interface 402 can axially move the divider 200 with respect to the longitudinal axis 106.

At 520, the individual can actuate the actuating device (e.g., the second dial) of the second interface 404 to adjust a depth of the first compartment 12 and a depth of the second compartment 14. Actuating the second interface 404 can axially move the base 300 with respect to the vertical axis 218.

Note, in another configuration, step 520 can occur first and step 510 can occur after step 520 or steps 510 and 520 can occur simultaneously (i.e., at the same time).

At 530, the individual positions containers in the first compartment 12 and/or the second compartment 14.

The adjustable cup holder 10 offers versatility, stability, and improved space utilization for one or more passengers of a vehicle, for example. Additionally, containers that would ordinarily be unstable within a traditional cup holder can be securely arranged within the adjustable cup holder 10. Thus, the adjustable cup holder 10 can enhance passengers' in-vehicle experience during travel.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An adjustable cup holder assembly, comprising:
a receptacle extending along a first axis;
a first rail arranged in the receptacle and parallel to the first axis;
a divider arranged in the receptacle and movable along the first axis, the divider defining a first compartment and a second compartment in the receptacle;
a second rail arranged in the divider along a second axis that is perpendicular to the first axis;
a base arranged in the receptacle and movable with respect to the second axis;
a first mechanism coupled to the divider and the first rail, the first mechanism being configured to adjust the divider with respect to the first axis; and
a second mechanism coupled to the base and the second rail, the second mechanism being configured to adjust the base with respect to the second axis.

2. The adjustable cup holder assembly of claim 1, wherein the receptacle comprises a floor and a continuous wall defining a first end and a second end, the first end being opposite the second end with respect to the first axis.

3. The adjustable cup holder assembly of claim 2, wherein the divider comprises a first side that faces the first end of the receptacle and a second side that faces the second end of the receptacle.

4. The adjustable cup holder assembly of claim 3, wherein the first compartment is defined between the first side and the first end and the second compartment is defined between the second side and the second end.

5. The adjustable cup holder assembly of claim 4, wherein the divider is movable so that a first diameter of the first compartment is larger than, smaller than, or the same size as a second diameter of the second compartment.

6. The adjustable cup holder assembly of claim 1, further comprising a first dial coupled to the first mechanism and configured to adjust the divider with respect to the first axis.

7. The adjustable cup holder assembly of claim 6, further comprising a second dial coupled to the second mechanism and configured to adjust the base with respect to the second axis.

8. The adjustable cup holder assembly of claim 7, wherein the first mechanism further comprises:
a first bevel gear configured to rotate about a third axis;
a second bevel gear configured to rotate about a first rail axis and in communication with the first bevel gear; and
a worm gear coupled to the second bevel gear and arranged to communicate with the first rail.

9. The adjustable cup holder assembly of claim 7, wherein the second mechanism further comprises:
a first bevel gear configured to rotate about a third axis;
a second bevel gear configured to rotate about a second rail axis and in communication with the first bevel gear; and
a worm gear coupled to the second bevel gear along a shaft and arranged to communicate with the second rail.

10. The adjustable cup holder assembly of claim 1, wherein the base further comprises a first pad and a second pad coupled to the first pad via a support member.

11. A vehicle cup holder assembly, comprising:
a cup holder base that is movable within a receptacle;
a first cup holder compartment having a first diameter between a first side of a divider and a first end of the receptacle;
a second cup holder compartment having a second diameter between a second side of the divider and a second end of the receptacle;
a first interface defining a first dial opening and comprising a first dial within the first dial opening;
a second interface defining a second dial opening and comprising a second dial within the second dial opening;
a first finger operated mechanism coupled to the first interface and configured to move the divider with respect to a first axis; and
a second finger operated mechanism coupled to the second interface and configured move the cup holder base with respect to a second axis that is perpendicular to the first axis.

12. The vehicle cup holder assembly of claim 11, wherein the first finger operated mechanism is configured to adjust the first diameter and the second diameter.

13. The vehicle cup holder assembly of claim 12, wherein the second finger operated mechanism is configured to move the cup holder base with respect to an upper surface of the receptacle.

14. The vehicle cup holder assembly of claim 11, wherein the cup holder base further comprises a first pad extending into the first cup holder compartment and a second pad extending into the second cup holder compartment, the first pad being coupled to second pad via a support member.

15. The vehicle cup holder assembly of claim 11, wherein the first dial and the second dial are configured to rotate with respect to a third axis that is perpendicular to the first axis and the second axis.

16. A method for adjusting a depth and a width within a cup holder, comprising:
actuating a first interface to adjust a diameter of a first compartment and a second compartment;
actuating a second interface to adjust a depth of a first compartment and a second compartment; and
positioning a container within the first compartment or the second compartment.

17. The method of claim 16, wherein the first interface is a first finger operated mechanism comprising a first dial.

18. The method of claim 17, wherein the second interface is a second finger operated mechanism comprising a second dial.

19. The method of claim 18, wherein actuating the first interface further comprises axially moving a divider with respect to a longitudinal axis.

20. The method of claim 19, wherein actuating the second interface further comprises axially moving a base with respect to a vertical axis.
